(19) United States
(12) Patent Application Publication
(10) Pub. No.: US 2025/0247655 A1
(43) Pub. Date: Jul. 31, 2025

(54) MICROPHONE SUSPENSION FOR MECHANICAL FEEDBACK REDUCTION IN HEARING DEVICES

(71) Applicant: Starkey Laboratories, Inc., Eden Prairie, MN (US)

(72) Inventors: Victor Klymko, Minneapolis, MN (US); Ryan Timothy Chester, Bloomington, MN (US); Jundong Li, Eden Prairie, MN (US)

(21) Appl. No.: 19/025,013

(22) Filed: Jan. 16, 2025

Related U.S. Application Data
(60) Provisional application No. 63/627,462, filed on Jan. 31, 2024.

(51) Int. Cl. H04R 25/00

(52) U.S. Cl. CPC H04R 25/45

(57) ABSTRACT

Disclosed herein, among other things, are systems and methods for microphone suspension for mechanical feedback reduction in hearing devices. A hearing device includes a housing, hearing electronics within the housing, a microphone not connected to the housing, and a flex connector. The flex connector is configured to electrically and mechanically connect the microphone to the hearing electronics, and the flex connector has a length to thickness ratio configured to lower a resonant frequency of the flex connector and the microphone below an audible range of interest.

### CLAIM OF PRIORITY AND INCORPORATION BY REFERENCE

The present application claims the benefit under 35 U.S.C. § 119 (e) of U.S. Provisional Patent Application 63/627,462, filed Jan. 31, 2024, the disclosure of which is hereby incorporated by reference herein in its entirety.

### TECHNICAL FIELD

This document relates generally to audio device systems and more particularly to systems and methods of microphone suspension for mechanical feedback reduction in hearing devices.

### BACKGROUND

Audio devices can be used to provide audible output to a user based on received wireless signals. Examples of audio devices include speakers and ear-wearable devices, also referred to herein as hearing devices. Example of hearing devices include hearing assistance devices or hearing instruments, including both prescriptive devices and non-prescriptive devices. Specific examples of hearing devices include, but are not limited to, hearing aids, headphones, and earbuds.

Hearing aids are used to assist patients suffering hearing loss by transmitting amplified sounds to ear canals. In one example, a hearing aid is worn in and/or around a patient's ear. Hearing aids may include processors and electronics that improve the listening experience for a specific wearer or in a specific acoustic environment.

One or more microphones may be used in hearing devices to sense audio signals to be processed by the hearing device before being played to the wearer using a receiver or speaker. Microphones in hearing devices are sensitive to mechanical vibration generated by receivers. Presently, microphones are rigidly fixed to the hearing device case, which allows for nearly lossless transmission of mechanical vibrations to the microphone within a broad frequency range, thus increasing sensitivity to vibrations and reducing the gain margin of the hearing device.

Thus, there is a need in the art for improved systems and methods for reducing mechanical feedback for microphones of ear-wearable devices.

### SUMMARY

Disclosed herein, among other things, are systems and methods for microphone suspension for mechanical feedback reduction in hearing devices. A hearing device includes a housing, hearing electronics within the housing, a microphone not connected to the housing, and a flex connector. The flex connector is configured to electrically and mechanically connect the microphone to the hearing electronics, and the flex connector has a length to thickness ratio configured to lower a resonant frequency of the flex connector and the microphone below an audible range of interest.

Various aspects include a method of suspending a microphone in a housing of a hearing assistance device. The method includes electrically and mechanically connecting the microphone to a cavity within the housing using a flex connector. The flex connector has a length to thickness ratio configured to lower a resonant frequency of the flex connector and the microphone below an audible range of interest, and the microphone is not connected to the housing.

This Summary is an overview of some of the teachings of the present application and not intended to be an exclusive or exhaustive treatment of the present subject matter. Further details about the present subject matter are found in the detailed description and appended claims.

### BRIEF DESCRIPTION OF THE DRAWINGS

Various embodiments are illustrated by way of example in the figures of the accompanying drawings. Such embodiments are demonstrative and not intended to be exhaustive or exclusive embodiments of the present subject matter.

FIG. 1 illustrates a hearing device with a microphone suspension for mechanical feedback reduction, according to various examples of the present subject matter.

FIG. 2A illustrates a top view of a microphone suspension for mechanical feedback reduction in a hearing device, according to various examples of the present subject matter.

FIG. 2B illustrates a side view of a microphone suspension for mechanical feedback reduction in a hearing device, according to various examples of the present subject matter.

FIG. 3 illustrates a graphical diagram of velocity gain or loss for a microphone suspension for mechanical feedback reduction in a hearing device, according to various examples of the present subject matter.

FIG. 4 illustrates a flow diagram of a method of suspending a microphone in a housing of a hearing assistance device, according to various examples of the present subject matter.

FIG. 5 illustrates a block diagram of a hearing device circuit, according to various examples of the present subject matter.

### DETAILED DESCRIPTION

The following detailed description of the present subject matter refers to subject matter in the accompanying drawings which show, by way of illustration, specific aspects and embodiments in which the present subject matter may be practiced. These embodiments are described in sufficient detail to enable those skilled in the art to practice the present subject matter. References to “an”, “one”, or “various” embodiments in this disclosure are not necessarily to the same embodiment, and such references contemplate more than one embodiment, including combinations of such embodiments. The following detailed description is demonstrative and not to be taken in a limiting sense. The scope of the present subject matter is defined by the appended claims, along with the full scope of legal equivalents to which such claims are entitled.

The present detailed description will discuss audio devices such as hearing devices and speakers. The description refers to hearing devices or hearing instruments generally, which include earbuds, headsets, headphones, and hearing assistance devices using the example of hearing aids. Other hearing devices include, but are not limited to, those in this document. It is understood that their use in the description is intended to demonstrate the present subject matter, but not in a limited or exclusive or exhaustive sense.

One or more microphones may be used in hearing devices to sense audio signals to be processed by the hearing device before being played to the wearer using a receiver or speaker. Microphones in hearing devices are sensitive to mechanical vibration generated by receivers. Presently, microphones are rigidly fixed to the hearing device case, which allows for nearly lossless transmission of mechanical vibrations to the microphone within a broad frequency range, thus increasing sensitivity to vibrations and reducing the gain margin of the hearing device.

The present subject matter provides a mechanical suspension that reduces microphone sensitivity to vibrations at audible frequencies and thus improves the gain margin in hearing devices, such as hearing assistance devices. The suspension also serves as an electric connection for the microphone. The microphone is not fixed to the housing, in various examples. In some examples, the amount of space needed around the microphone and estimated microphone displacement and velocity are calculated using a finite element method (FEM) simulation.

The present mechanical/electrical suspension system, including a flex connector and microphone(s), are configured, in shape and mass, to have resonant frequency below a practical audible range of interest, but above the frequency of footsteps. The mechanical response of the suspended microphone at frequencies above resonance is reduced due to general mechanical properties of resonant systems, which reduces the vibration sensitivity of the microphone at frequencies above the suspension system resonance.

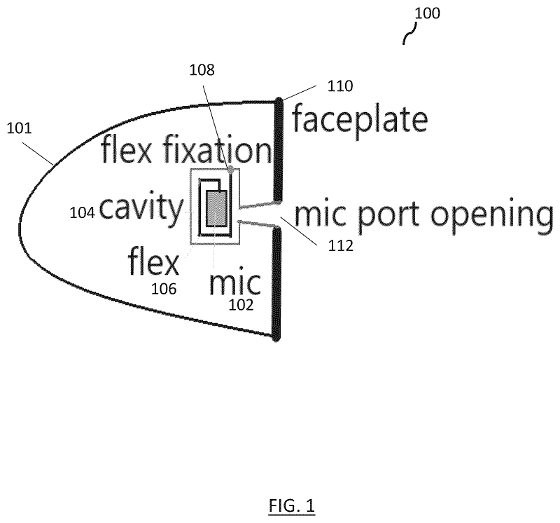

FIG. 1 illustrates a hearing device with a microphone suspension for mechanical feedback reduction, according to various examples of the present subject matter. The hearing device 100 includes a housing 101, hearing electronics within the housing, a microphone 102 not connected to the housing, and a flex connector 106. The flex connector 106 is configured to electrically and mechanically connect the microphone 102 to the hearing electronics and/or to an inside surface of a cavity 104 in the housing at a flex fixation point 108, and the flex connector 106 has a length to thickness ratio configured to lower a resonant frequency of the flex connector 106 and the microphone 102 below an audible range of interest. In various examples, the flex connector 106 has a mass stiffness ratio configured to lower a resonant frequency of the flex connector and the microphone below an audible range of interest. The flex connector 106 includes the hearing electronics, in various examples.

The housing 101 includes a microphone port opening 112 to create an acoustic channel to the cavity 104, in some examples. In one example, the microphone port opening 112 is in a faceplate 110 of the housing. The hearing device 100 is a hearing assistance device, such as a hearing aid, in some examples. Other types of hearing devices may be used without departing from the scope of the present subject matter. In various examples, the microphone 102 is suspended by its electric connection at the end of an acoustic channel in a custom hearing aid.

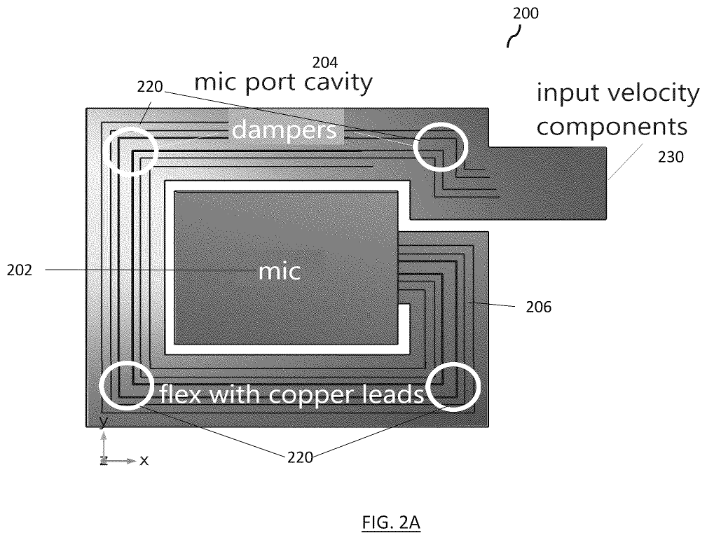

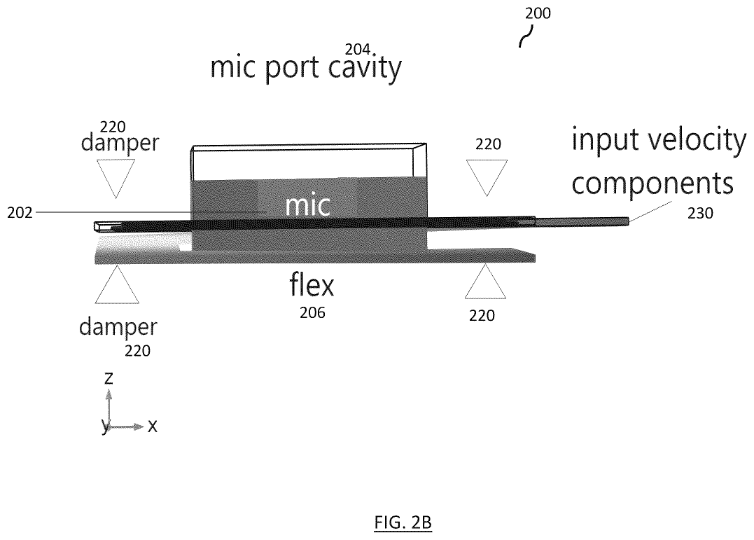

FIG. 2A illustrates a top view of a microphone suspension for mechanical feedback reduction in a hearing device 200, according to various examples of the present subject matter. According to various examples, the microphone 202 and the flex (or flex connector 206) are oriented in a vertical plane with respect to a wearer of the hearing device 200. The flex connector 206 is configured to electrically and mechanically connect the microphone 202 to the hearing electronics and/or to an inside surface of a cavity 204 in the housing, and the flex connector 206 has a length to thickness ratio configured to lower a resonant frequency of the flex connector 206 and the microphone 202 below an audible range of interest. In some examples, the hearing device 200 includes an input for velocity components. The flex connector 206 is configured to connect to the hearing circuit at 230, in various examples.

In various examples, the hearing device 200 further includes mechanical dampers 220 configured to absorb impact of the microphone 202 and/or the flex connector 206. The mechanical dampers 220 are cylindrical, conical, rectangular or hemispherical in shape, in some examples. Other shapes may be used without departing from the scope of the present subject matter. The mechanical dampers 220 are positioned above the microphone 202 and the flex connector 206, in one example. In another example, the mechanical dampers 220 are positioned below the microphone 202 and the flex connector 206. The mechanical dampers 220 may be affixed to an interior surface of the housing, in some examples.

A layer of damping material may be provided on one or more sides of the flex connector 206 configured to dampen mechanical vibration of the flex connector configured to absorb the vibration being transferred to the microphone 202, in various examples. The layer of damping material includes a polymer or plastic material, in some examples. Other materials may be used without departing from the scope of the present subject matter. FIG. 2B illustrates a side view of a microphone suspension for mechanical feedback reduction in a hearing device, according to various examples of the present subject matter.

The microphone is usually connected to an electric circuit inside the hearing aid via a thin polyimide printed circuit board (PCB) flex with copper leads embedded into polyimide. Previously, the microphone was fixed to the plastic case or housing. In the present subject matter, a small cavity is created around the microphone, where the microphone is suspended on its flex. The previous flex connector is modified to have a sufficient length to thickness ratio to lower the resonant frequency of the system for a given microphone mass, yet occupy minimum space. The additional space for the microphone is a trade-off for improved gain margin of the hearing aid in some frequency ranges, in various examples. The system (flex connector and microphone) stiffness in three perpendicular directions is refined for performance using the present subject matter: out of plane of the microphone membrane, in plane along the flex copper leads entering the microphone, and in plane but transverse to copper leads, each dependent on frequency.

One example of the present suspension of the microphone by its flex connection inside a cavity at the end of acoustic channel in a hearing device is shown in FIG. 1. For production handling, the microphone can be first placed in a cartridge frame, the end of the flex fixed to the cartridge, and the microphone floating inside the cartridge. The cartridge with the microphone can then be inserted into the hearing device and form the end of the acoustic channel. The cartridge is not used for the suspension purpose, in other examples. In various examples, the mechanical properties of the suspension are determined by the mass of the microphone, length of the flex (or flex connector) between its fixation point at the cavity wall and the microphone, the flex width, thickness and/or the Young's moduli of its materials.

A suspension of the microphone creates a risk for it to move freely during motion of the user's body. The microphone may impact the cavity walls and cause abrupt, unpleasant sound perception. Several design measures can be implemented to prevent this. In one example, to prevent microphone impact with cavity walls, the microphone and its flex are oriented in vertical plane. The flex is stiffest in its plane and softest in the out-of-plane direction. This orientation minimizes the motion of the microphone during walking or jumping (at low frequencies).

In another example, to prevent microphone impact with cavity walls dampers (such as the dampers 220 shown in FIG. 2B) can be positioned above and below the microphone and the flex plane (dampers oriented in a horizontal direction) in order to absorb the impact of the mic against the cavity wall if the microphone does move far enough. In yet another example, to prevent microphone impact with cavity walls, a thin layer of rubber-like damping material can be deposited on each side of the flex to dampen its vibration before it moves far enough and hits the dampers on the cavity walls. However, the use of the thin layer of damping material would have to be accounted for in calculating resonance of the combined system, in various examples.

As an example, a suspension system was optimized running a sequence of FEM simulations, using a microphone mass of 18 mg and properties of commonly-used flex PCB. Based on these values, proposed flex dimensions for an embodiment of the present microphone suspension for are estimated, as shown in FIGS. 2A-2B. As discussed above, these figures provide a top view (FIG. 2A) and a side view (FIG. 2B) of a microphone suspension on its flex with optional dampers. In this example, the new flex has the same materials, same width and thickness of polyimide substrate and copper traces, but different length and shape to provide the proper strength and resonance. To save space, the flex connector follows the perimeter of the microphone with small gap between the connector and the microphone, in this example. The microphone and the flex are to be placed in a cavity at the end of microphone port, with cavity dimensions determined by predicted motion of the microphone, in various examples. The end of the flex is fixed to the cavity wall. This fixed end of the flex moves with vibration velocity transferred from receiver via the hearing aid housing, in various examples. The cavity has an opening that leads to acoustic channel to open space outside the device (not shown). In some examples, dampers made of a polymer material can be used to lower the vibration peaks and for shock absorption, as shown.

In the first, static step of the simulation, sagging of the microphone due to gravity is calculated to be 16 μm, which provides an estimation for the cavity dimensions, in one example. The gravity is applied in the Z direction shown in FIGS. 2A-2B. The motion of the microphone at higher frequencies is calculated to be much less than static sagging due to gravity, in various examples.

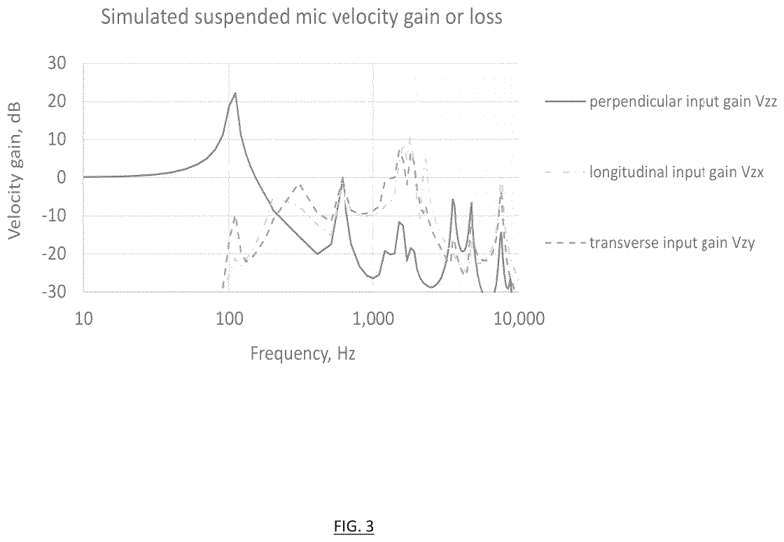

In the second step of the simulation, the fixed end of the flex is moved with previously measured receiver (speaker) vibration velocity, and the microphone vibration velocity response is simulated. In three separate simulations, the receiver vibration velocity is applied at the end of the flex suspension in three perpendicular directions: along the copper leads (the X direction), perpendicular to the copper leads in plane of the microphone membrane (the Y direction), and out of plane of the microphone membrane (the Z direction). In some examples, the orientation of the microphone is perpendicular to the receiver. The coordinate system is shown in FIGS. 2A-2B and simulation results are shown in FIG. 3.

FIG. 3 illustrates a graphical diagram of velocity gain or loss for a microphone suspension for mechanical feedback reduction in a hearing device, according to various examples of the present subject matter. This depicts a simulated suspended microphone velocity referred to measured receiver velocity components. The ratios of the Z component of the microphone velocity to different components of the input case velocity are shown in FIG. 3 for the X component of the input, the Y component of the input, and the Z component of the input. By design, a micro-electromechanical system (MEMS) microphone is most sensitive in the Z direction, perpendicular to its membrane. The velocity gain for each component represents the energy transfer to the mic and is calculated as:

$${V}_{z β} = 20 \cdot log ( \frac{{V}_{mic z}}{{V}_{in β}} ) , β = x , y , z$$

All negative values for the curve in FIG. 3 indicate vibration reduction and therefore provide additional gain margin for the hearing device. With the flex design in this example, the natural resonance frequency of the flex and microphone system in the Z direction is at the lower edge of practical audiblerange. This frequency can be lowered further by rounding the corners of the flex and traces, extending their length or reducing their thickness or width, in various examples. For vibration in the Z direction, the vibration reduction is observed at all frequencies above 150 Hz, except for a narrow band near 600 Hz. For the two other perpendicular directions of input vibration, there is a risk zone between 1.5 kHz and 2.5 kHz, where the relevant velocity gains are positive. In some examples, the flex is positioned around the microphone to lower vibration frequency below the frequency of the receiver. The dimensions and shape of the flex can be further optimized to minimize vibration transfer in all directions above the main resonance, in various examples. Additional dampers can be used above and below the flex, as shown in FIGS. 2A-2B.

In various examples, vibration can be further reduced by embedding the flex (or flex connector) into a soft acoustic tube that guides the acoustic wave to the microphone, with dimensions adjusted to keep the resonant frequency low. The present microphone suspension by its electrical connection creates additional, tunable gain margin for custom and standard hearing device products and improves their stability.

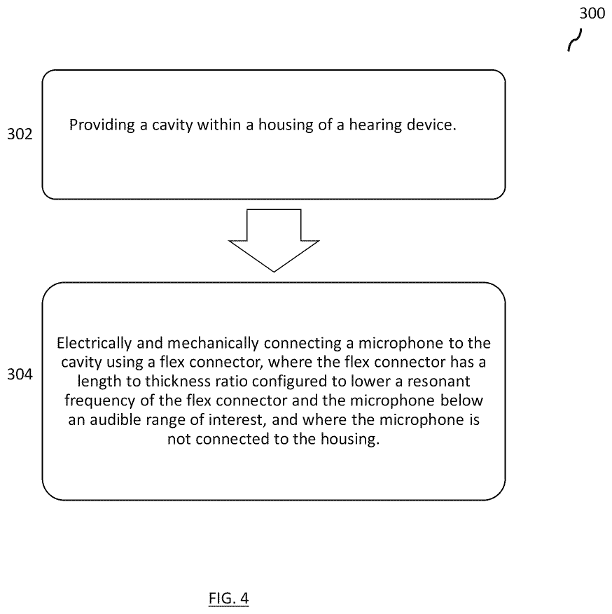

FIG. 4 illustrates a flow diagram of a method of suspending a microphone in a housing of a hearing assistance device, according to various examples of the present subject matter. The method 300 may optionally include providing a cavity within a housing of a hearing device, at step 302. At step 304, the method 300 includes electrically and mechanically connecting a microphone to the cavity using a flex connector, where the flex connector has a length to thickness ratio configured to lower a resonant frequency of the flex connector and the microphone below an audible range of interest, and where the microphone is not connected to the housing.

According to various examples, the microphone includes a MEMS microphone. In other examples, the microphone may be an electret microphone that is soldered or connected to the flex. Other types of microphones may be used without departing from the scope of the present subject matter. In some examples, the method 300 further includes calculating dimensions of the cavity based on predicted motion of the microphone during use by a wearer of the hearing assistance device. The housing includes a microphone port opening to create an acoustic channel to the cavity, in some examples. In one example, the microphone port opening is in a faceplate of the housing. The method 300 further includes embedding the flex connector into an acoustic tube configured to guide an acoustic wave to the microphone, in various examples. The flex connector includes rounded corners configured to lower the resonant frequency, in some examples. The method 300 may further include placing the microphone in a cartridge frame, wherein the microphone is configured to float inside the cartridge frame, and affixing an end of the flex connector to the cartridge frame. The length to thickness ratio is calculated based on a mass of the microphone, in some examples. As indicated, the present suspension may be used with any hearing device, including but not limited to a hearing assistance device such as a hearing aid.

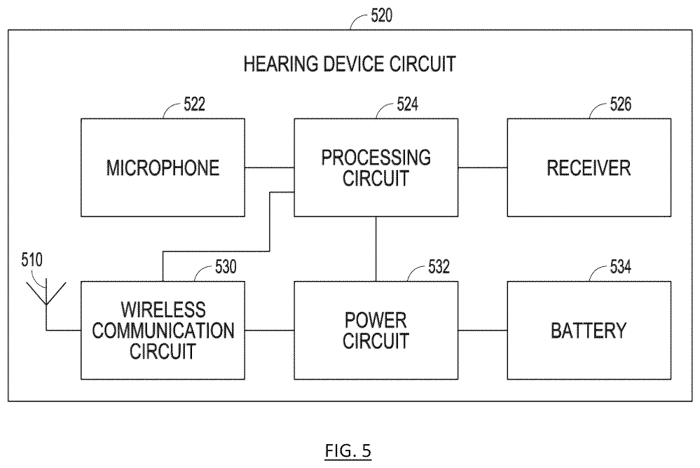

FIG. 5 illustrates a block diagram of a hearing device circuit, according to various examples of the present subject matter. Hearing device circuit 520 represents an example of portions of a hearing device and includes a microphone 522, a wireless communication circuit 530, an antenna 510, a processing circuit 524, a receiver (speaker) 526, a battery 534, and a power circuit 532. Microphone 522 receives sounds from the environment of the hearing device user (wearer of the hearing device). Wireless communication circuit 530 communicates with another device wirelessly using antenna 510, including receiving programming codes, streamed audio signals, and/or other audio signals and transmitting programming codes, audio signals, and/or other signals. Examples of the other device includes other hearing devices of other users, another hearing device of a pair of hearing devices for the same wearer, a hearing device host device, an assistive listening device (ALD), an audio streaming device, a smartphone, and other devices capable of communicating with hearing devices wirelessly. Processing circuit 524 controls the operation of hearing device using the programming codes and processes the sounds received by microphone 522 and/or the audio signals received by wireless communication circuit 530 to produce output sounds. Receiver 526 transmits output sounds to an ear canal of the hearing device wearer. Battery 534 and power circuit 532 constitute the power source for the operation of hearing device circuit 520. In one example, power circuit 532 can include a power management circuit. In another alternative or additional example, battery 534 can include a rechargeable battery and power circuit 532 can include a recharging circuit for recharging the rechargeable battery.

In various examples, the hearing device includes a microphone suspension for mechanical feedback reduction. The hearing device circuit 520 includes at least one processor or processing circuit 524 and data storage in communication with the processing circuit 524. The data storage comprises instructions thereon that, when executed by the processing circuit 524, causes the processing circuit 524 to perform the functions of the present systems and methods. The hearing device circuit 520 may be included in an ear bud, headphones, a hearing aid, or other ear-wearable device, in various examples.

Various examples of the present subject matter support wireless communications with a hearing device. In various examples the wireless communications may include standard or nonstandard communications. Some examples of standard wireless communications include link protocols including, but not limited to, Bluetooth™, BLE, Auracast, IEEE 802.11 (wireless LANs), 802.15 (WPANs), 802.16 (WiMAX), cellular protocols including, but not limited to CDMA and GSM, ZigBee, and ultra-wideband (UWB) technologies. Such protocols support radio frequency communications and some support infrared communications while others support NFMI. Although the present system is demonstrated as a radio system, it is possible that other forms of wireless communications may be used such as ultrasonic, optical, infrared, and others. It is understood that the standards which may be used include past and present standards. It is also contemplated that future versions of these standards and new future standards may be employed without departing from the scope of the present subject matter.

The wireless communications support a connection from other devices. Such connections include, but are not limited to, one or more mono or stereo connections or digital connections having link protocols including, but not limited to 802.3 (Ethernet), 802.4, 802.5, USB, SPI, PCM, ATM, Fibre-channel, Firewire or 1394, InfiniBand, or a native streaming interface. In various examples, such connections include all past and present link protocols. It is also contemplated that future versions of these protocols and new future standards may be employed without departing from the scope of the present subject matter.

Hearing assistance devices typically include at least one enclosure or housing, a microphone, hearing assistance device electronics including processing electronics, and a speaker or “receiver.” Hearing assistance devices may include a power source, such as a battery. In various examples, the battery is rechargeable. In various examples multiple energy sources are employed. It is understood that in various examples the microphone is optional. It is understood that in various examples the receiver is optional. It is understood that variations in communications protocols, antenna configurations, and combinations of components may be employed without departing from the scope of the present subject matter. Antenna configurations may vary and may be included within an enclosure for the electronics or be external to an enclosure for the electronics. Thus, the examples set forth herein are intended to be demonstrative and not a limiting or exhaustive depiction of variations.

It is understood that digital hearing assistance devices include a processor. In digital hearing assistance devices with a processor, programmable gains may be employed to adjust the hearing assistance device output to a wearer's particular hearing impairment. The processor may be a digital signal processor (DSP), microprocessor, microcontroller, other digital logic, or combinations thereof. The processing may be done by a single processor, or may be distributed over different devices. The processing of signals referenced in this application may be performed using the processor or over different devices. Processing may be done in the digital domain, the analog domain, or combinations thereof. Processing may be done using subband processing techniques. Processing may be done using frequency domain or time domain approaches. Some processing may involve both frequency and time domain aspects. For brevity, in some examples drawings may omit certain blocks that perform frequency synthesis, frequency analysis, analog-to-digital conversion, digital-to-analog conversion, amplification, buffering, and certain types of filtering and processing. In various examples of the present subject matter the processor is adapted to perform instructions stored in one or more memories, which may or may not be explicitly shown. Various types of memory may be used, including volatile and nonvolatile forms of memory. In various examples, the processor or other processing devices execute instructions to perform a number of signal processing tasks. Such examples may include analog components in communication with the processor to perform signal processing tasks, such as sound reception by a microphone, or playing of sound using a receiver (i.e., in applications where such transducers are used). In various examples of the present subject matter, different realizations of the block diagrams, circuits, and processes set forth herein may be created by one of skill in the art without departing from the scope of the present subject matter.

It is further understood that different hearing devices may embody the present subject matter without departing from the scope of the present disclosure. The devices depicted in the figures are intended to demonstrate the subject matter, but not necessarily in a limited, exhaustive, or exclusive sense. It is also understood that the present subject matter may be used with a device designed for use in the right ear or the left ear or both ears of the wearer.

The present subject matter is demonstrated for hearing devices, including hearing assistance devices, including but not limited to, behind-the-ear (BTE), in-the-ear (ITE), in-the-canal (ITC), receiver-in-canal (RIC), invisible-in-canal (IIC) or completely-in-the-canal (CIC) type hearing assistance devices. It is understood that behind-the-ear type hearing assistance devices may include devices that reside substantially behind the ear or over the ear. Such devices may include hearing assistance devices with receivers associated with the electronics portion of the behind-the-ear device, or hearing assistance devices of the type having receivers in the ear canal of the user, including but not limited to RIC or receiver-in-the-ear (RITE) designs. The present subject matter may also be used in hearing assistance devices generally, such as cochlear implant type hearing devices. The present subject matter may also be used in deep insertion devices having a transducer, such as a receiver or microphone. The present subject matter may be used in bone conduction or otherwise osseointegrated hearing devices, in some examples. The present subject matter may be used in devices whether such devices are standard or custom fit and whether they provide an open or an occlusive design. It is understood that other hearing devices not expressly stated herein may be used in conjunction with the present subject matter.

### Other Notes and Examples

Example 1 is a hearing assistance device including a housing, hearing assistance electronics within the housing, a microphone not connected to the housing, and a flex connector configured to electrically and mechanically connect the microphone to the hearing assistance electronics, wherein the flex connector has a length to thickness ratio configured to lower a resonant frequency of the flex connector and the microphone below an audible range of interest.

In Example 2, the subject matter of Example 1 optionally includes wherein the microphone and the flex connector are oriented in a vertical plane with respect to a wearer of the hearing assistance device.

In Example 3, the subject matter of Example 1 or Example 2 optionally further includes mechanical dampers configured to absorb vibration being transferred to the microphone.

In Example 4, the subject matter of Example 3 optionally includes wherein the mechanical dampers are cylindrical, conical, rectangular or hemispherical in shape.

In Example 5, the subject matter of Example 3 optionally includes wherein the mechanical dampers are positioned above the microphone and the flex connector.

In Example 6, the subject matter of Example 3 optionally includes wherein the mechanical dampers are positioned below the microphone and the flex connector.

In Example 7, the subject matter of Example 3 optionally includes wherein the mechanical dampers are affixed to an interior surface of the housing.

In Example 8, the subject matter of any of Examples 1-7 optionally further includes a layer of damping material on each side of the flex connector configured to dampen mechanical vibration of the flex connector configured to absorb impact of the microphone.

In Example 9, the subject matter of Example 8 optionally includes wherein the layer of damping material includes a polymer or plastic material.

In Example 10, the subject matter of any of Examples 1-9 optionally includes wherein the flex connector has a mass stiffness ratio configured to lower a resonant frequency of the flex connector and the microphone below an audible range of interest.

Example 11 is method of suspending a microphone in a housing of a hearing assistance device, the method including electrically and mechanically connecting the microphone to a cavity within the housing using a flex connector, wherein the flex connector has a length to thickness ratio configured to lower a resonant frequency of the flex connector and the microphone below an audible range of interest, and wherein the microphone is not connected to the housing.

In Example 12, the subject matter of Example 11 optionally includes wherein the microphone includes a micro-electromechanical system (MEMS) or electret microphone.

In Example 13, the subject matter of Example 11 or Example 12 optionally further includes calculating dimensions of the cavity based on predicted motion of the microphone during use by a wearer of the hearing assistance device.

In Example 14, the subject matter of any of Examples 11-13 optionally includes wherein the housing includes a microphone port opening to create an acoustic channel to the cavity.

In Example 15, the subject matter of Example 14 optionally includes wherein the microphone port opening is in a faceplate of the housing.

In Example 16, the subject matter of any of Examples 11-15 optionally further includes embedding the flex connector into an acoustic tube configured to guide an acoustic wave to the microphone.

In Example 17, the subject matter of any of Examples 11-16 optionally includes wherein the hearing assistance device includes a behind-the-ear (BTE) or receiver-in-canal (RIC) hearing aid.

In Example 18, the subject matter of any of Examples 11-17 optionally further includes placing the microphone in a cartridge frame, wherein the microphone is configured to float inside the cartridge frame, and affixing an end of the flex connector to the cartridge frame.

In Example 19, the subject matter of any of Examples 11-18 optionally includes wherein the length to thickness ratio is calculated based on a mass of the microphone.

In Example 20, the subject matter of any of Examples 11-16, 18 or 19 optionally includes wherein the hearing assistance device includes an in-the-ear (ITE) hearing aid.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

This application is intended to cover adaptations or variations of the present subject matter. It is to be understood that the above description is intended to be illustrative, and not restrictive. The scope of the present subject matter should be determined with reference to the appended claims, along with the full scope of legal equivalents to which such claims are entitled.

What is claimed is:

1. A hearing assistance device, comprising:
a housing;
hearing assistance electronics within the housing;
a microphone not connected to the housing; and
a flex connector configured to electrically and mechanically connect the microphone to the hearing assistance electronics, wherein the flex connector has a length to thickness ratio configured to lower a resonant frequency of the flex connector and the microphone below an audible range of interest.

2. The hearing assistance device of claim 1, wherein the microphone and the flex connector are oriented in a vertical plane with respect to a wearer of the hearing assistance device.

3. The hearing assistance device of claim 1, further comprising:
mechanical dampers configured to absorb vibration being transferred to the microphone.

4. The hearing assistance device of claim 3, wherein the mechanical dampers are cylindrical, conical, rectangular or hemispherical in shape.

5. The hearing assistance device of claim 3, wherein the mechanical dampers are positioned above the microphone and the flex connector.

6. The hearing assistance device of claim 3, wherein the mechanical dampers are positioned below the microphone and the flex connector.

7. The hearing assistance device of claim 3, wherein the mechanical dampers are affixed to an interior surface of the housing.

8. The hearing assistance device of claim 1, further comprising:
a layer of damping material on each side of the flex connector configured to dampen mechanical vibration of the flex connector configured to absorb impact of the microphone.

9. The hearing assistance device of claim 8, wherein the layer of damping material includes a polymer or plastic material.

10. The hearing assistance device of claim 1, wherein the flex connector has a mass stiffness ratio configured to lower a resonant frequency of the flex connector and the microphone below an audible range of interest.

11. A method of suspending a microphone in a housing of a hearing assistance device, the method comprising:
electrically and mechanically connecting the microphone to a cavity within the housing using a flex connector, wherein the flex connector has a length to thickness ratio configured to lower a resonant frequency of the flex connector and the microphone below an audible range of interest, and wherein the microphone is not connected to the housing.

12. The method of claim 11, wherein the microphone includes a micro-electromechanical system (MEMS) or electret microphone.

13. The method of claim 11, further comprising:
calculating dimensions of the cavity based on predicted motion of the microphone during use by a wearer of the hearing assistance device.

14. The method of claim 11, wherein the housing includes a microphone port opening to create an acoustic channel to the cavity.

15. The method of claim 14, wherein the microphone port opening is in a faceplate of the housing.

16. The method of claim 11, further comprising:
embedding the flex connector into an acoustic tube configured to guide an acoustic wave to the microphone.

17. The method of claim 11, wherein the hearing assistance device includes a behind-the-ear (BTE) or receiver-in-canal (RIC) hearing aid.

18. The method of claim 11, further comprising:
placing the microphone in a cartridge frame, wherein the microphone is configured to float inside the cartridge frame; and
affixing an end of the flex connector to the cartridge frame.

19. The method of claim 11, wherein the length to thickness ratio is calculated based on a mass of the microphone.

20. The method of claim 11, wherein the hearing assistance device includes an in-the-ear (ITE) hearing aid.
